(19) United States
(12) Patent Application Publication
(10) Pub. No.: US 2025/0050596 A1
(43) Pub. Date: Feb. 13, 2025

(54) Method for manufacturing a preform for a wind turbine blade

(71) Applicant: LM WIND POWER A/S, Kolding (DK)

(72) Inventors: Frederik BRANDT, Kolding (DK); Kristian Lehmann MADSEN, Kolding (DK)

(21) Appl. No.: 18/718,935

(22) PCT Filed: Feb. 3, 2023
(86) PCT No.: PCT/EP2023/052666

§ 371 Date: Jun. 12, 2024

(30) Foreign Application Priority Data
Feb. 8, 2022 (EP) 22155685.5

(51) Int. Cl. B29C 70/44; B29C 70/54; B29L 31/08

(52) U.S. Cl. CPC B29C 70/44; B29C 70/54; B29L 2031/085

(57) ABSTRACT

The present invention relates to a method of manufacturing a part, such as a preform, for a wind turbine blade. One or more channel members (72) are fastened to the mould surface of a preform mould, and a fibre material (85) and a binding agent is arranged on the mould surface (87). The fibre material, the binding agent and the one or more channel members are covered with a vacuum bag, and negative pressure is applied to the fibre material and binding agent via the one or more channel members for consolidating the preform. Each of the channel members (72) comprises a plurality of slits (77) extending between its inner surface and its outer surface, the slits having an orientation that is substantially transverse to the longitudinal axis of the channel member.

### FIELD OF THE INVENTION

The present invention relates to a method of manufacturing a preform for a wind turbine blade, to a mould assembly for carrying out said method, and to a method of manufacturing a wind turbine blade part.

### BACKGROUND OF THE INVENTION

Climate change has created an urgent need for sustainable energy, putting the spotlight on wind power as a cost-effective and clean energy source. Wind turbines typically comprise a tower, generator, gearbox, nacelle, and one or more rotor blades, which capture kinetic energy of wind using known airfoil principles. With increasing energy demand, modern wind turbines can have power ratings of above 10 MW and may have rotor blades that exceed 100 meters in length.

Wind turbine rotor blades are typically made from a fibre-reinforced polymer material, comprising a pressure side shell half and a suction side shell half, also called blade halves. The cross-sectional profile of a typical blade includes an airfoil for creating an air flow leading to a pressure difference between both sides. The resulting lift force generates torque for producing electricity.

The shell halves of rotor blades are often manufactured using blade moulds. First, a blade gel coat or primer is applied to the mould. Subsequently, fibre reinforcement and/or fabrics are placed into the mould followed by resin infusion. A vacuum is typically used to draw epoxy resin material into a mould. Alternatively, prepreg technology can be used in which a fibre or fabric pre-impregnated with resin forms a homogenous material which can be introduced into the mould. Several other moulding techniques are known for manufacturing wind turbine blades, including compression moulding and resin transfer moulding. The shell halves are assembled by being glued or bolted together substantially along a chord plane of the blade.

In such blade manufacturing processes, the use of preforms has become increasingly important. A preform is a shaped arrangement of fibres, such as multiple layers thereof, which has been bound and/or consolidated for later use as part of the fibre lay-up in the blade mould. The rationale for using preforms for blade manufacturing is to reduce cycle time in the blade mould. In addition, using preforms may reduce the number of required repairs due to the pre-consolidated structure of the preforms. As blade lengths increase, using preforms for blade lay-up adds efficiency and precision.

Typically, multiple preforms will be used in manufacturing a wind turbine blade. This usually requires large space for manufacturing and for storing the preforms. In addition, the manufacturing of preforms of different shapes and sizes can be time-consuming and expensive. Providing moulds for manufacturing preforms can be tedious and costly, which applies even more if preforms of various shapes and curvatures are required.

In addition, the manufacturing of preforms typically involves a consolidation step applying negative pressure or vacuum during the preform manufacturing process. Existing techniques for applying vacuum in such settings use polymer vacuum profiles or perforated tubes. Such vacuum channels can also be formed as an omega-shaped profile body. In some applications, perforated vacuum tubes are used, which are reinforced with a spiral-shaped rigid body, which extends inside the tube and prevents the latter from collapsing due to the vacuum.

These known solutions suffer from a number of problems involving high wear of the vacuum profiles as well as insufficient flexibility when moulding preforms of various shapes and sizes. This adds to manufacturing costs as typically a high number of vacuum profiles is required for forming a plurality of wind turbine blade preforms.

It is therefore a first object of the present invention to provide a more cost-efficient way of manufacturing preforms for wind turbine blade parts.

It is a further object of the present invention to provide a more flexible and efficient mode of manufacturing such preforms.

It is another object of the present invention to provide a simplified mould assembly for forming preforms, which reduces layup mistakes and which has a longer lifetime than known mould assemblies.

### SUMMARY OF THE INVENTION

The present invention addresses one or more of the above-discussed objects by providing a method of manufacturing a part for a wind turbine blade, the method comprising the steps of providing a mould comprising a mould surface, fastening one or more channel members to the mould surface, each channel member having a longitudinal axis, an inner surface and an opposing outer surface, laying a fibre material and optionally a binding agent on the mould surface, covering the fibre material, the optional binding agent and the one or more channel members with a vacuum bag, and applying negative pressure to the fibre material and the optional binding agent via the one or more channel members for consolidating the part, wherein each channel member comprises a plurality of slits extending between its inner surface and its outer surface, the slits having an orientation that is substantially transverse to the longitudinal axis of the channel member. Preferably, the part is a preform, and the mould is preferably a preform mould. It is also preferred that a binding agent is indeed used in the method.

Thus, in a particularly preferred embodiment, the present invention relates to a method of manufacturing a preform for a wind turbine blade, the method comprising the steps of
providing a preform mould comprising a mould surface,
fastening one or more channel members, preferably elongate channel members, to the mould surface, each channel member having a longitudinal axis, an inner surface and an opposing outer surface,
laying a fibre material and a binding agent on the mould surface,
covering the fibre material, the binding agent and the one or more channel members with a vacuum bag, and
applying negative pressure to the fibre material and binding agent via the one or more channel members for consolidating the preform, and
preferably applying heat to the fibre material and binding agent to form the preform,
   wherein each channel member comprises a plurality of slits extending between its inner surface and its outer surface. The slits preferably have an orientation that is substantially transverse or substantially perpendicular to the longitudinal axis of the channel member.

It was found that such channel members allow to precisely follow even complex geometries of the mould, such as the preform mould, while providing the required vacuum consolidation in a uniform and reproducible manner. A vacuum in this connection is understood as a negative pressure, which is advantageously passed to the moulding cavity via the vacuum channels of the present invention.

In some embodiments, the part is a segment of a wind turbine blade. In other embodiments the part is an intermediate product for a wind turbine blade. It is particularly preferred that the part is a preform for use in manufacturing a wind turbine blade.

Preferably, the preform to be manufactured by the present method is a consolidated arrangement of material comprising fibres, such as glass fibres, and a binding agent. The preform will typically be used for manufacturing a blade half of a wind turbine blade. The preforms can be used in a subsequent blade moulding process as part of the fibre lay-up in the blade mould, such as a blade half mould. The preforms manufactured according to the present invention can be placed within the root region of a blade mould, thus constituting part of the root laminate. The root region may correspond to a region of the blade having a substantially circular or elliptical cross-section. However, the preforms could also be used for other parts and regions of a wind turbine blade, such as trailing edge or leading edge reinforcements or adhesive flanges. Alternatively, the preforms could be used for a full blade layup, or the central load carrying laminates as the main laminate.

The preform mould used in the method of the present invention may be of a type comprising one or more support elements and a plurality of strip members arranged on the one or more support elements. Preferably, each of the strip members comprises a top surface extending between a first lateral edge and an opposing second lateral edge, a groove extending along the first lateral edge, a tongue extending along the second lateral edge, and a sealing member arranged in the groove, wherein the strip members are arranged in juxtaposition, and wherein the tongue of a strip member is fixed, preferably releasably fixed, within the groove of an adjacent strip member, preferably such that the tongue abuts the sealing member, the respective top surfaces of the strip members forming a moulding surface for moulding the preform.

In some embodiments, the mould surface of the preform mould has a length of between 15 and 30 meters. In other embodiments, the mould surface of the preform mould has a width of 2-5 meters. In some embodiments, the preform mould has a height of between 0.5 and 2 meters. The mould surface of the preform mould may have a moulding surface area of between 10 and 100 square meters, such as between 30 and 80 square meters, preferably between 50 and 70 square meters. In a preferred embodiment, the mould surface is substantially gas tight.

In some embodiments, each preform mould has a length-width ratio of at least 5:1. In other embodiments, each preform mould has a length-width ratio of at least 5:1, such as at least 10:1. In a preferred embodiment, each preform mould has a length-width ratio of at least 15:1. In some embodiments, each preform mould has a length-width ratio of up to 100:1.

In a preferred embodiment, each of the preforms obtainable by the preform mould of the present invention is configured to form a blade section starting from the root end of the wind turbine blade. Thus, preferably each of the preforms obtainable by the preform mould of the present invention is configured to be arranged at the root end of the blade mould. Most preferably, the preform obtainable using the preform mould of the present invention is configured to form a subsection of the root section extending from the root end of the blade together with other subsections of the root section equally extending from the root end of the blade.

In some embodiments, the preform moulds of the present invention comprise a mould surface configured for the manufacturing of respective subsections of a wind turbine blade, each subsection extending from the root end of the wind turbine blade. In some embodiments, the preform mould has a concave, or inwardly curved, mould surface.

The step of fastening the one or more channel members to the mould surface can advantageously be carried out by bonding the channel members to the mould surface using an adhesive. In a preferred embodiment, the channel members are fastened by an adhesive tape, preferably double adhesive tape, or by using a suitable glue. Such arrangements with adhesive ensure that the arrangement is vacuum tight, as opposed to using screws or rivets as fastening devices. It is preferred that each channel member is fastened such that it is aligned with a length direction or longitudinal axis of the preform mould. Preferably, two opposing channel members are fastened to the mould surface such that they extend substantially parallel to a respective lateral edge of the mould surface. The two opposing channel members that are fastened to the mould surface may be spaced from the respective lateral edge of the mould surface, for example with a substantially constant distance over the length of the mould surface. Preferably, the channel members extend along at least 80%, preferably along at least 90% of the length of the mould surface.

The channel member of the present invention is preferably an elongated channel member. Each channel member has a length extending along its longitudinal axis. The length is preferably at least 2 meters, such as at least 3 meters. In a preferred embodiment, the channel member comprises a channel which is open to one side, preferably downwardly open, such that a longitudinally extending conduit can be formed between the channel member and the mould surface.

A channel is preferably defined by an inner surface of the channel member, the channel preferably having a substantially semi-circular or U-shaped cross section. The inner surface of the channel member typically faces towards the mould surface when the channel member is fastened to the mould surface of the preform mould. Typically, the opposing outer surface of the channel member faces towards the fibre material when moulding the preform.

Each channel member comprises a plurality of slits or slots extending between its inner surface and its outer surface, the slits or slots preferably having an orientation that is substantially transverse or perpendicular to the longitudinal axis of the channel member. Preferably the length of the slits in the channel member is at least one quarter, more preferably at least half, of the width of the channel member. Thus, it is particularly preferred that the slits extend only along part of the width of the channel member.

The fibre laying step will typically comprise the use of one or more fibre lay-up devices. In a preferred embodiment, the method further comprises a step of heating the fibre material and the binding agent to form a preform. Preferably, the fibre material and the binding agent are heated, preferably during or following the consolidation step, using one or more heating devices, such as an oven. Preferably, a binding agent is added to the fibres prior to the heating step. The binding agent can be applied to the fibre material during layup on the preform mould. In other embodiments, the binding agent is applied to the fibre material prior to the layup of the fibre material. Such binding agent is preferably present in an amount of 0.1-15 wt % relative to the weight of the fibre material. The binding agent may also be present in an amount of 10-20 gram per square meter of glass surface. In other embodiments, the binding agent may be present in an amount of 1-100 gram per square meter of glass surface.

Typically, the fibre material is placed successively onto the moulding surface together with the binding agent. The fibre material may comprise glass fibres, carbon fibres or a combination thereof. According to a preferred embodiment of the method, a glass fibre material is placed onto the strip members, such as multiple layers of glass fibre material. The fibre material may advantageously be brought into contact with a binding agent before or during the fibre lay-up.

In another embodiment, the fibre material may include fibre rovings, such as glass fibre rovings. The lay-up process may include placing multiple single roving bundles into the mould, the roving bundles being preferably aligned unidirectionally. In a preferred embodiment, multiple layers of fibre rovings or roving bundles are successively placed onto each preform mould.

The binding agent may also be present in an amount of 5-40, preferably 10-20, gram per square meter of fibre surface. In preferred embodiments, the binding agent is present in an amount of 0.5-5 wt %, preferably 0.5-2.5 wt %, relative to the weight of the fibre material. Advantageously, the binding agent is a thermoplastic binding agent. The binding agent may comprise a polyester, preferably a bisphenolic polyester.

In a preferred embodiment, a heating step is carried out during or after applying negative pressure to the fibre material and binding agent, wherein heating of the fibre material and the binding agent takes place at a temperature of between 4° and 200° C., preferably between 9° and 160° C.

An example of a suitable binding agent is a polyester marketed under the name NEOXIL 940. Examples include NEOXIL 940 PMX, NEOXIL 940 KS 1 and NEOXIL 940 HF 2B, all manufactured by DSM Composite Resins AG. Another example is a polyester resin marketed under the name C.O.I.M. FILCOR 661 FPG 005, which is a bisphenolic unsaturated polyester resin in powder form. Preferably, the binding agent is a polyester, preferably a bisphenolic polyester. In other embodiments, the binding agent is a hotmelt adhesive or based on a prepreg resin. In some embodiments, the preform comprises an epoxy material.

According to another embodiment, the binding agent is a thermoplastic binding agent. Typically, the fibre material comprises fibre rovings which are at least partially joined together by means of the binding agent by thermal bonding. In a preferred embodiment, the binding agent is a binding powder, such as a thermoplastic binding powder.

In one embodiment, the preforms of the present invention essentially consist of the fibre material and the binding agent. This means that the preforms contain no more than 10 wt %, preferably not more than 5 wt % or not more than 1 wt %, of material other than fibre material and binding agent relative to the total weight of the preform. According to another embodiment, the preform consists of the fibre material and the binding agent.

In another embodiment, the fibre material used for the preforms of the present invention essentially consists of glass fibres. This means that the fibre material contains not more than 10 wt %, preferably not more than 5 wt % or not more than 1 wt %, of material other than glass fibres relative to the total weight of the fibre material. According to another embodiment, the fibre material consists of glass fibres.

In one embodiment, the binding agent is present in an amount of 1-6 wt % relative to the weight of the fibre material. According to another embodiment, the melting point of the binding agent is between 40° and 220° C., preferably between 4° and 160° C. According to another embodiment, the binding agent comprises a polyester, preferably a bisphenolic polyester.

In one embodiment of the present invention, each preform essentially consists of the fibre material and the binding agent. According to another embodiment, the fibre material comprises fibre rovings, preferably glass fibre rovings. In other embodiments, the fibre material may comprise carbon fibres or a hybrid material. According to another embodiment, the fibre material comprises a fibre fabric, such as a fibre mat. In another embodiment, a preform may further comprise at least one fibre fabric such as a fibre mat. Fibre rovings may be arranged on top and/or below such fabric.

In a preferred embodiment, the preforms manufactured according to the afore-mentioned method are used as part of the root region of a wind turbine blade, such as the root laminate. The root region may extend up to 40 meters, such as up to 25 meters, from the root end of the blade, as seen in its longitudinal direction. In other embodiments, the root region may extend to the shoulder of the blade+/−5 meters. However, the preforms could also be used for other parts and regions of a wind turbine blade. In other embodiments, the preforms manufactured according to the afore-mentioned method are used over a length of 10-35% of the total blade length. In another embodiment, the preforms manufactured according to the afore-mentioned method are used in a region of the blade extending between its root end and a shoulder of the blade.

The fibre material, the binding agent and the one or more channel members are covered with a vacuum bag, such as a disposable vacuum bag or single-use vacuum bag for providing a vacuum chamber that allows consolidation of the fibre material of the preform. To form the moulding cavity, the periphery of the vacuum bag can be sealed to the mould, preferably by using a sealant tape, e.g. comprising a double sided adhesive, such as tacky tape.

Vacuum or negative pressure is then applied to the fibre material and binding agent via the one or more channel members for consolidating the preform. Advantageously, the slits of each channel member provide a passageway for air flow, withdrawing air from the moulding cavity through the slits, passing a channel or passageway in the channel member, and finally towards a source of vacuum which preferably is connected to the preform mould by a hose coupled to one or more openings in the moulding surface. In this way an improved distribution of air flow is achieved, leading to a more uniform compression or consolidation of the fibre material.

Thus, in a preferred embodiment, air can be withdrawn from underneath the vacuum bag through the slits of the channel member(s) by a vacuum source connected to the moulding assembly. In a preferred embodiment, two channel members are fastened to the mould surface, such that a respective channel member is placed on either lateral side, such as a left-hand side and a right-hand side, of the mould surface. This can be advantageously used to guide the fibre layup process while ensuring that the negative pressure is applied evenly across the entire fibre material. It is preferred that the method further comprises the step of heating the fibre material and the binding agent to a temperature of between 4° and 200° C. to form the preform.

In a preferred embodiment, each channel member has a length, or longitudinal extent, and a width, or transverse extent, wherein each of the plurality of slits extends along 10-90%, preferably 40-90%, most preferably 60-90% of the width or transverse extent of the channel member. This was found to provide an improved flexibility of the channel members which are thus able to follow even a curved profile of the mould surface, while at the same time still providing sufficient structural stability to avoid breaking of the channel members.

In a preferred embodiment, the slits are formed as transverse cuts. The transverse cuts advantageously make the profile flexible to follow the curvature of each preform. The transverse cuts can be placed at regular intervals along the longitudinal direction of the channel member, e.g. every 5-15 cm, such as every 10 cm, along the length of the channel member.

In a preferred embodiment, each channel member has a first lateral edge and an opposing second lateral edge, wherein each of the plurality of slits passes through the second lateral edge. Thus, in a preferred embodiment, each of the plurality of slits extends from the second lateral edge in a transverse direction through the body of the channel member. Preferably, each of the plurality of slits terminates at a transverse distance spaced apart from the first lateral edge, wherein said transverse distance preferably equals 1-50%, preferably 10-35%, of the width of the channel member.

In embodiments wherein the channel member comprises a first longitudinally extending portion defining a hollow passageway, and a substantially flat second longitudinally extending portion laterally adjacent to the first portion, it is preferred that the plurality of slits extends throughout said second portion and through part of said first portion. In embodiments wherein the channel member comprises a first longitudinally extending portion defining a hollow passageway, and a substantially flat second longitudinally extending portion laterally adjacent to the first portion, it is particularly preferred that the channel members are fastened such to the mould surface that the first portion is closer to a respective lateral edge of the mould surface and the second portion is closer to the center of the mould surface, preferably such that the second portions of two opposing channel members face each other. Typically, the preform mould has an elongate mould surface with a length which is at least double its width. The longitudinally extending lateral edges of the said mould surface, such as a left lateral edge and an opposing right lateral edge, extend in the length direction of the preform mould.

In a preferred embodiment, the slits are regularly spaced along the longitudinal axis of the channel member. Thus, a slit can be provided for every 5-15 cm, such as every 10 cm of the length of the channel member. In a preferred embodiment, the slits are parallel to each other. It is preferred that the orientation of the slits is substantially perpendicular to the length extension or longitudinal axis of the channel member.

In a preferred embodiment, the step of laying a fibre material and a binding agent on the mould surface comprises partially covering the channel member with the fibre material and binding agent, preferably while aligning the fibre material with the alignment feature of the channel member. Typically, the channel member will be covered up to an alignment feature or reference line provide within its outer surface. In embodiments wherein the channel member comprises a first longitudinally extending portion defining a hollow passageway, and a substantially flat second longitudinally extending portion laterally adjacent to the first portion, it is particularly preferred that at least part of the second portion is covered with the fibre material and binding agent, whereas the first portion is not covered.

In a preferred embodiment, each channel member comprises a hollow profile, such as a hollow profile with an inverted U-shaped or cross section. In another preferred embodiment, each channel member comprises a hollow profile with a substantially semi-circular cross section. In other embodiments, the hollow profile can have a rectangular or triangular cross section. Preferably, the channel member has a uniform cross section along its entire length. Typically, the channel member will have a first opening at its proximal end, and a second opening at its distal end, seen in the longitudinal direction.

In a preferred embodiment, the channel member is re-usable. Thus, in some embodiments, the channel member(s) are permanently adhered to the mould surface for repeated use in manufacturing preforms. Since typically no resin is infused by vacuum application during the preform manufacturing process, the channel members can be used for multiple preform manufacturing cycles.

In a preferred embodiment, the channel member is flexible. It is particularly preferred that the channel member is bendable to follow a substantially curved path. This is achieved by providing the plurality of slits in the channel members of the present invention.

In a preferred embodiment, the channel member is an elongate vacuum channel or vacuum profile. Preferably, the channel member has a length of at least 2 meters, more preferably between 2 and 30 meters, most preferably between 10 and 30 meters. The width (transverse extent) of the channel member is preferably between 30 and 200 mm, most preferably between 40 and 100 mm. The height of the channel member is preferably between 10 and 100 mm, most preferably between 10 and 30 mm.

Preferably, the channel member comprises a longitudinally extending reference line for guiding the fibre layup process, i.e. for instructing operators where the fibre material has to be placed on the mould surface. In a preferred embodiment, the outer surface of the channel member comprises an alignment feature such as a reference mark or a patterned region. In a preferred embodiment, the alignment feature is substantially parallel to the longitudinal axis of the channel member.

In a preferred embodiment, the alignment feature comprises an indentation, preferably a longitudinally extending indentation, in the outer surface of the channel member, the indentation extending along the length of the channel member.

In a preferred embodiment, each channel member comprises a first portion extending along the longitudinal axis of the channel member and defining a hollow passageway. Preferably, the hollow passageway is downwardly open to form a conduit defined between the channel member and the mould surface. In a preferred embodiment, each channel member also comprises a second portion adjacent to the first portion in the width direction, the second portion extending along the longitudinal axis of the channel member, wherein the second portion is substantially flat or plate shaped.

In a preferred embodiment, the first portion of the channel member comprises one or more feet or webs extending inwardly from the inner surface of the channel member. The one or more feet or webs preferably extend along the entire length of the channel member. Such arrangement is particularly useful when using a preform mould comprising plurality of strip members having a groove extending along the first lateral edge, and a tongue extending along the second lateral edge, as described herein. The longitudinally extending feet or webs can advantageously help to stabilize the arrangement in particular in regions of two neighbouring strip members, thus preventing displacement of the tongue from the groove. Preferably, the feet or webs have a length sufficient for them to extend all the way down to the mould surface. In a preferred embodiment, each channel member comprises two opposing longitudinally extending feet or webs extending from the inner surface of the channel member. Thus, the one or more feet or webs preferably extend within a hollow profile of the channel member.

In a preferred embodiment, the first portion comprises an arched wall and wherein the second portion comprises a straight wall. It is particularly preferred that the second portion is formed as a longitudinally extending plate which lies in a substantially horizontal plane. Thus, the plate can be advantageously placed flat onto the mould surface of the preform mould.

In a preferred embodiment, the first portion has a substantially U-shaped or semi-circular transverse cross section. In a preferred embodiment, each channel member has a substantially P-shaped transverse cross section.

In a preferred embodiment, the channel member is made of a metal material such as aluminium or stainless steel. Such embodiments are particularly useful for obtaining a heat resistant vacuum channel. Typically, the fibre material and binding agent is heated during or after consolidation to form the preform. Known vacuum channels or profiles do typically not withstand the heat that is applied during this step. Commercially available vacuum spirals/profiles are usually made of a plastic material, which can melt during heating of the fibre material and binding agent.

In a preferred embodiment, the mould surface has a first longitudinally extending lateral edge and an opposing second longitudinally extending lateral edge, and wherein a first channel member is arranged on the mould surface along the first longitudinally extending lateral edge, and wherein a second channel member is arranged on the mould surface along the second longitudinally extending lateral edge.

In a preferred embodiment, each channel member is an elongate channel member. In a preferred embodiment, each channel member is in fluid communication with a vacuum source. Preferably, one or more hoses are used to connect the channel members with the vacuum source. In a preferred embodiment, the hose(s) are attached at an opening or hole provided in the preform mould to establish fluid communication with the channel members.

In a preferred embodiment, the method further comprises the step of heating the fibre material and the binding agent after or during the step of applying negative pressure. In a preferred embodiment, the method further comprises the step of heating the fibre material and the binding agent, preferably to a temperature of between 4° and 200° C., such as 100-130° C., to form the preform.

In a preferred embodiment, the preform mould comprises one or more openings, such as one or more cylindrical openings, such as one or more through holes, formed in the mould surface, each opening being in communication with a vacuum source, each opening being covered by a channel member, preferably by a hollow profile of the channel member.

In another aspect, the present invention relates to a method of manufacturing a wind turbine blade part, the method comprising:
manufacturing one or more preforms according to the method of the present invention,
arranging the preforms in a blade mould cavity, optionally together with additional material,
infusing resin to the blade mould cavity,
curing or hardening the resin in order to form the blade part.

In some embodiments, the method of manufacturing a wind turbine blade part may involve arranging preforms in a prefab mould with subsequent infusing of resin and curing for manufacturing sub parts for later blade assembly. In some embodiments, the wind turbine blade part is a root laminate, a main laminate or a part thereof. In another embodiment, the blade part is a blade half.

Typically, the resin infusion step comprises vacuum assisted resin transfer moulding. In a preferred embodiment, the resin dissolves the binding agent of the preform. Other embodiments involve chemical binding, for example for epoxy or thermoset resins.

The resin for injecting the preform during the manufacturing of wind turbine blade parts, such as a root laminate, may be an epoxy, a polyester, a vinyl ester or another suitable thermoplastic or duroplastic material. In other embodiments, the resin may be a thermosetting resin, such as epoxy, vinyl ester or polyester, or a thermoplastic resin, such as nylon, PVC, ABS, polypropylene or polyethylene.

In another aspect, the present invention relates to a mould assembly for carrying out a method according to the present invention, the mould assembly comprising
a mould, preferably a preform mould, comprising a mould surface, and
one or more channel members, each channel member extending along a longitudinal axis and having an inner surface and an opposing outer surface,
   wherein each channel member comprises a plurality of slits extending between its inner surface and its outer surface, the slits preferably having an orientation that is substantially transverse to the longitudinal axis of the channel member.

In a preferred embodiment, each channel member has a first lateral edge and an opposing second lateral edge, wherein each of the plurality of slits passes through the second lateral edge. In a preferred embodiment, each channel member comprises a first portion extending along the longitudinal axis of the channel member and defining a hollow passageway, and a substantially flat second portion laterally adjacent to the first portion, the second portion extending along the longitudinal axis of the channel member. In a preferred embodiment, the channel member is re-usable. Advantageously, the channel member(s) are permanently fixed, e.g. using to an adhesive, to the mould surface of the preform mould of the mould assembly. Other features and embodiments of the channel member discussed above with respect to the method of the present invention likewise apply to this aspect of the present invention.

In another aspect, the present invention relates to a channel member as described above, preferably for use in a method of manufacturing a part, preferably a preform, as described above. The channel member is preferably formed as an elongate vacuum channel or an elongate vacuum profile, the channel member extending along a longitudinal axis and having an inner surface and an opposing outer surface, wherein the channel member comprises a plurality of slits extending between its inner surface and its outer surface, the slits preferably having an orientation that is substantially transverse or substantially perpendicular to the longitudinal axis of the channel member. In a preferred embodiment, the channel member comprises a first portion extending along the longitudinal axis of the channel member and defining a hollow passageway, and a substantially flat second portion laterally adjacent to the first portion, the second portion extending along the longitudinal axis of the channel member. Preferably, the channel member has a first lateral edge and an opposing second lateral edge, wherein each of the plurality of slits passes through the second lateral edge. Other features and embodiments of the channel member discussed above with respect to the method of the present invention likewise apply to this aspect of the present invention.

It will be understood that any of the embodiments and features described above in relation to the method of manufacturing a preform for a wind turbine blade likewise apply to the moulding assembly and to the channel member of the present invention, and vice versa.

In another aspect, the present invention relates to a plurality of parts, preferably a plurality of preforms, obtainable by the afore-described method. The present invention also relates to a blade part obtainable by the method of manufacturing a wind turbine blade part.

As used herein, the term “wt %” means weight percent. The term “relative to the weight of the fibre material” means a percentage that is calculated by dividing the weight of an agent, such as a binding agent, by the weight of the fibre material. As an example, a value of 1 wt % relative to the weight of the fibre material corresponds to 10 g of binding agent per kilogram of fibre material.

As used herein, the term “longitudinal” means an axis or direction running substantially parallel to the maximum linear dimension of the element in question, for example a channel member or a preform mould.

### DETAILED DESCRIPTION OF THE INVENTION

The invention is explained in detail below with reference to embodiments shown in the drawings, in which

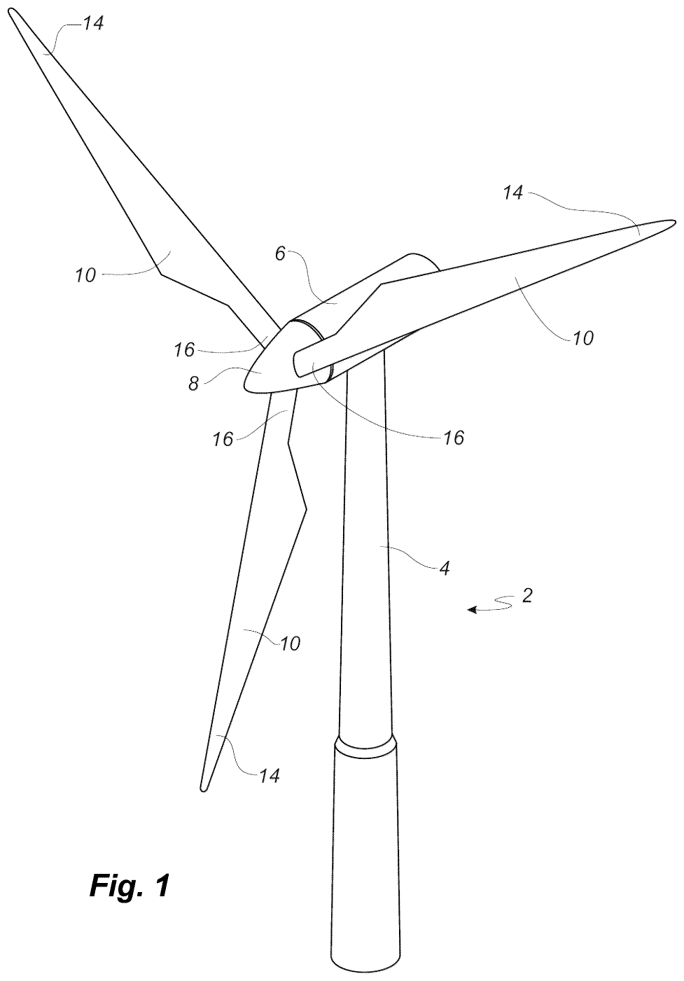

FIG. 1 shows a wind turbine,

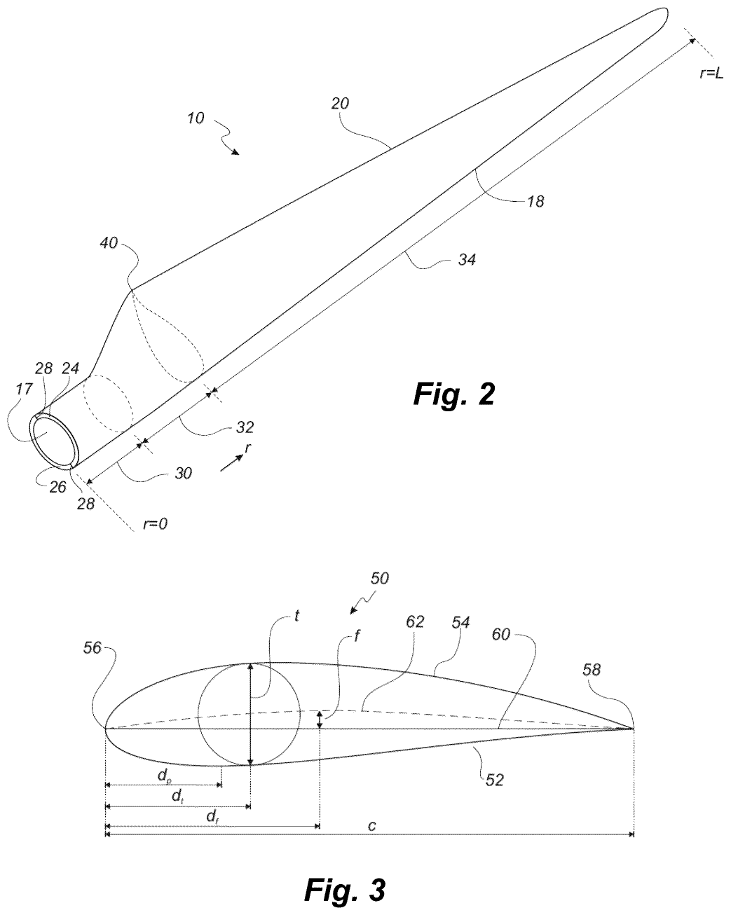

FIG. 2 shows a schematic view of a wind turbine blade,

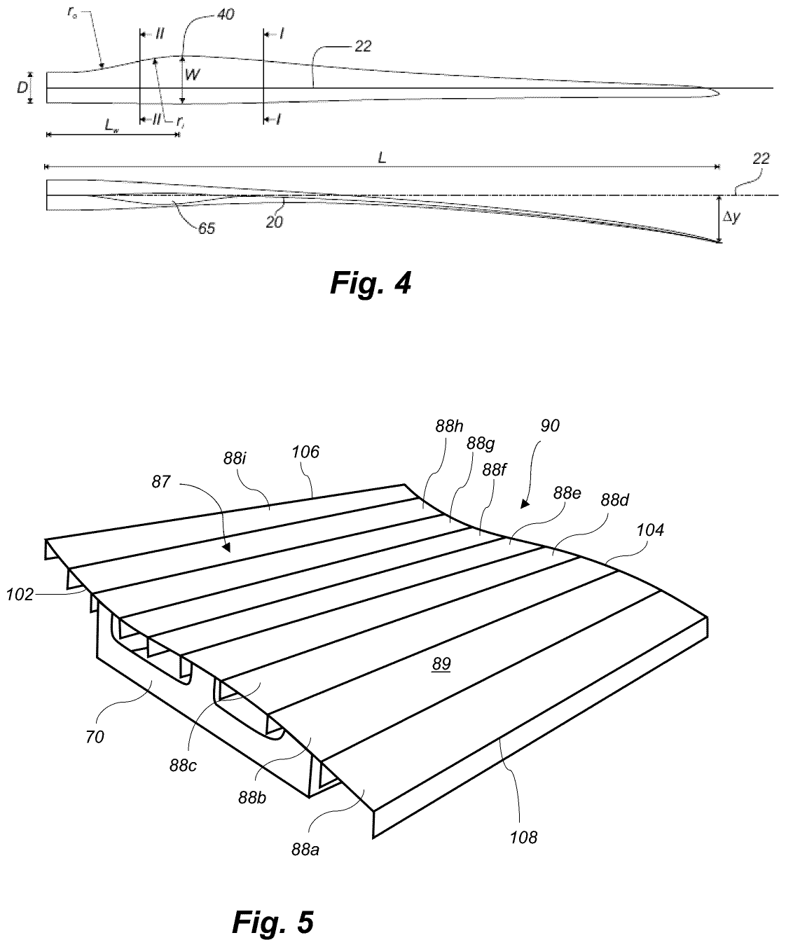

FIG. 3 shows a schematic view of an airfoil profile through section I-I of FIG. 4,

FIG. 4 shows a schematic view of the wind turbine blade, seen from above and from the side,

FIG. 5 is a perspective drawing of a preform mould,

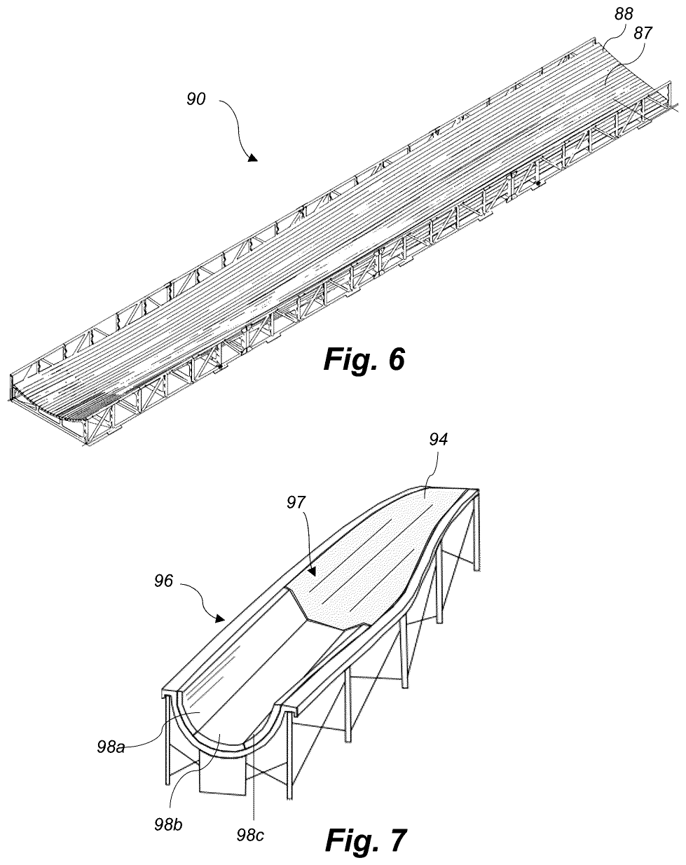

FIG. 6 is a perspective drawing of another embodiment of a preform mould,

FIG. 7 is a perspective drawing of a blade mould for lay up of preforms according to the present invention,

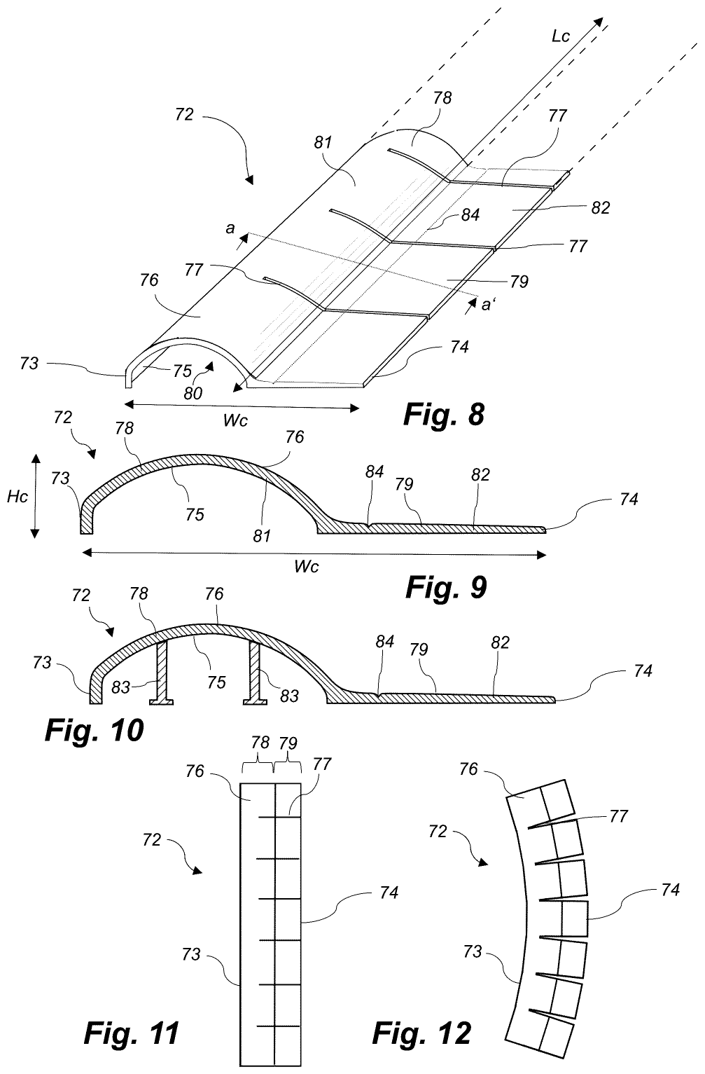

FIG. 8 is a perspective partial view of a channel member according to the present invention,

FIGS. 9 and 10 are cross sectional views of channel member according to embodiments of the present invention,

FIGS. 11 and 12 are schematic top views of a channel member according to the present invention, and

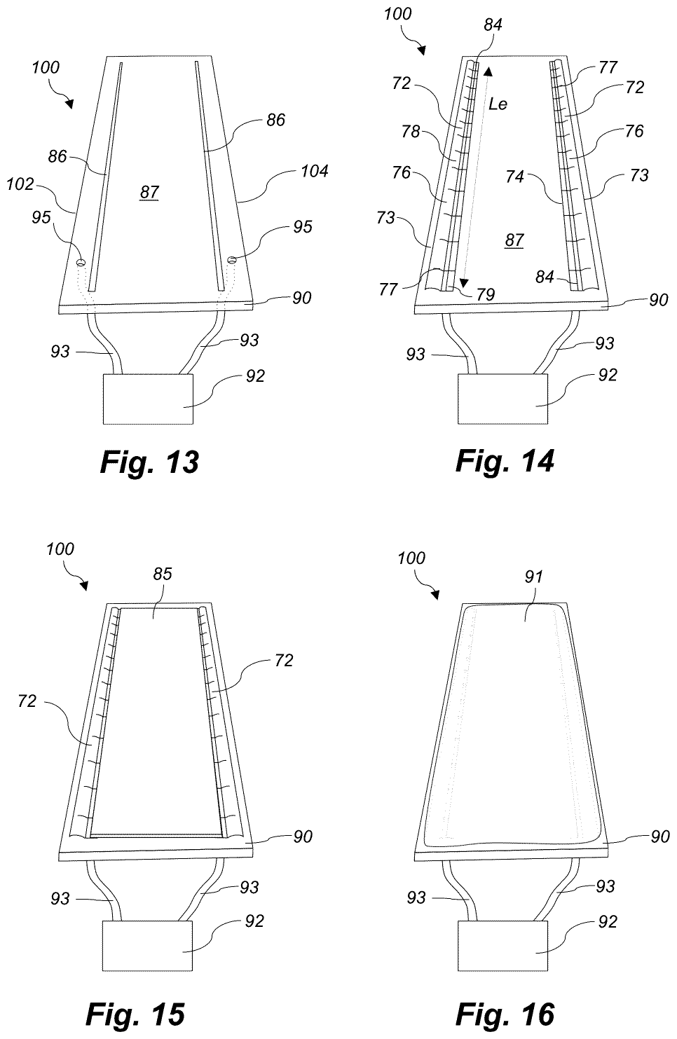

FIGS. 13-16 are perspective views of a moulding assembly illustrating various steps of the method of forming a preform of the present invention.

### DETAILED DESCRIPTION

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

FIG. 2 shows a schematic view of an embodiment of a wind turbine blade 10 according to the invention. The wind turbine blade 10 has the shape of a conventional wind turbine blade and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

FIGS. 3 and 4 depict parameters which are used to explain the geometry of the wind turbine blade according to the invention. FIG. 3 shows a schematic view of an airfoil profile 50 of a typical blade of a wind turbine depicted with the various parameters, which are typically used to define the geometrical shape of an airfoil. The airfoil profile 50 has a pressure side 52 and a suction side 54, which during use—i.e. during rotation of the rotor—normally face towards the windward (or upwind) side and the leeward (or downwind) side, respectively. The airfoil 50 has a chord 60 with a chord length c extending between a leading edge 56 and a trailing edge 58 of the blade. The airfoil 50 has a thickness t, which is defined as the distance between the pressure side 52 and the suction side 54. The thickness t of the airfoil varies along the chord 60. The deviation from a symmetrical profile is given by a camber line 62, which is a median line through the airfoil profile 50. The median line can be found by drawing inscribed circles from the leading edge 56 to the trailing edge 58. The median line follows the centres of these inscribed circles and the deviation or distance from the chord 60 is called the camber f. The asymmetry can also be defined by use of parameters called the upper camber (or suction side camber) and lower camber (or pressure side camber), which are defined as the distances from the chord 60 and the suction side 54 and pressure side 52, respectively.

Airfoil profiles are often characterised by the following parameters: the chord length c, the maximum camber f, the position dr of the maximum camber f, the maximum airfoil thickness t, which is the largest diameter of the inscribed circles along the median camber line 62, the position dₜ of the maximum thickness t, and a nose radius (not shown). These parameters are typically defined as ratios to the chord length c. Thus, a local relative blade thickness t/c is given as the ratio between the local maximum thickness t and the local chord length c. Further, the position dₚ of the maximum pressure side camber may be used as a design parameter, and of course also the position of the maximum suction side camber.

FIG. 4 shows other geometric parameters of the blade. The blade has a total blade length L. As shown in FIG. 3, the root end is located at position r=0, and the tip end located at r=L. The shoulder 40 of the blade is located at a position r=_{L}w, and has a shoulder width W, which equals the chord length at the shoulder 40. The diameter of the root is defined as D. The curvature of the trailing edge of the blade in the transition region may be defined by two parameters, viz. a minimum outer curvature radius rₒ and a minimum inner curvature radius rᵢ, which are defined as the minimum curvature radius of the trailing edge, seen from the outside (or behind the trailing edge), and the minimum curvature radius, seen from the inside (or in front of the trailing edge), respectively. Further, the blade is provided with a prebend, which is defined as Δy, which corresponds to the out of plane deflection from a pitch axis 22 of the blade.

FIG. 5 is a schematic perspective drawing of a known preform mould 90. The preform mould 90 comprises a support element 70 and nine strip members 88a-i arranged on the support element 70. Each of the strip members 88a-i has a top surface 89. Together, the top surfaces of the respective strip members form a moulding surface 87 for moulding a preform for a rotor blade moulding process. The moulding surface 87 extends between a left edge 102, a right edge 104, a rear edge 106 and a front edge 108. FIG. 6 illustrates another embodiment of a preform mould 90 comprising a support element a plurality of strip members 88 arranged on the support element to form a moulding surface 87 for moulding a preform for a rotor blade moulding process.

As illustrated in FIG. 7, the manufactured preforms 98a, 98b, 98c can be laid up in a blade mould 96 to form part of a wind turbine blade, such as the root laminate. It is particularly preferred that the preforms manufactured according to the present invention are used for a blade section starting from the root end of the blade, such as the root region. The preforms 98a, 98b, 98c are arranged in the blade mould cavity 97, usually together with additional fibre material 94. Then, resin is infused to the blade mould cavity 97, which is subsequently cured or hardened in order to form the blade part, such as a blade half.

FIGS. 8-12 illustrate various details of a channel member of the present invention. As seen in the partial perspective view of FIG. 8, the channel member 72 is a generally elongate member extending along longitudinal axis Lc. The channel member has an inner surface 75 and an opposing outer surface 76. A plurality of slits 77 extend between the inner surface 75 and its outer surface 76, the slits 77 having an orientation that is substantially transverse to the longitudinal axis Lc of the channel member 72.

As best seen in FIGS. 8, 11 and 12, each channel member 72 has a first lateral edge 73 and an opposing second lateral edge 74, wherein each of the plurality of slits 77 passes through the second lateral edge 74. The length Le of the channel member 72 is indicated in FIG. 14. Also, the channel member has a width Wc and a height Hc, as indicated in FIGS. 8 and 9. In the illustrated embodiments, each of the plurality of slits 77 extends along about 70-80% of the width or transverse extent of the channel member 72.

As also illustrated in FIG. 8, the channel member 72 comprises a first portion 78 extending along the longitudinal axis Lc of the channel member 72 and defining a hollow passageway 80. The channel member 72 also comprises a substantially flat second portion 79 laterally adjacent to the first portion 78, the second portion also extending along the longitudinal axis of the channel member 72. In the illustrated embodiment, the first portion 78 comprises an arched wall 81 and the second portion 79 comprises a straight wall 82.

FIG. 9 is a cross sectional view of the channel member 72 of FIG. 8, taken along the line a-a′. FIG. 10 is a cross sectional view of a channel member of another embodiment. Here, the first portion 78 of the channel member 72 comprises two longitudinally extending ribs or webs 83 extending from the inner surface 75 of the channel member 72. These ribs or webs 83 may provide structural support to the channel member 72, for preventing deformation and/or displacement. As best seen in FIGS. 9 and 10, the channel member 72 preferably has a substantially P-shaped transverse cross section.

It is also preferred that the outer surface 76 of the channel member 72, preferably the outer surface of the flat second portion 79, comprises an alignment feature in the form of a longitudinally extending indentation 84, the indentation extending along the length of the channel member 72, as shown in FIGS. 8, 9 and 10. Such alignment feature 84 is advantageous in guiding the fibre layup process in the method of manufacturing the preform. This method is described in the following with reference to the process steps and the mould assembly 100 illustrated in FIGS. 13-16.

The method of manufacturing a preform for a wind turbine blade comprises the provision of a preform mould 90 comprising a mould surface 87. In the embodiment shown in FIGS. 13-16, the preform mould is substantially flat, however, other shapes can be used, as illustrated in the examples of FIGS. 5 and 6. Preferably, an adhesive tape 86 is fastened to the mould surface 87 along the respective lateral edges 102, 104 of the mould 90, see FIG. 13. The tape 86 extends longitudinally and is provided for subsequent attachment of the channel members 72.

As also seen in FIG. 13, the preform mould 90 comprises two cylindrical openings 95, one at each lateral side, formed in the mould surface 87. Each opening 95 is in fluid communication with a vacuum source 92, using a respective tube 93. When fastening the channel members 72 to the mould surface, each opening 95 is covered by a channel member 72, preferably such the opening is located underneath the first portion 78 forming the passageway.

As shown in FIG. 14, the channel members 72 are fastened to the mould surface 87, each channel member 72, on top of the adhesive tape 86. Then, a fibre material 85 and a binding agent is laid on the mould surface 87, preferably such that the channel member 72 is partially covered with the fibre material and binding agent, i.e. using the alignment features 84 as guidance; see FIG. 15. Subsequently, the fibre material 85, the binding agent and the channel members are covered with a vacuum bag 91; see FIG. 16. Negative pressure can then be applied to the fibre material and binding agent via the channel members 72, using the vacuum source 92 and connected tubes 93. Thereby, the fibre layup is consolidated. Advantageously, heat is applied during or after this step to further join the fibres using the binding agent, to form the preform.

The invention is not limited to the embodiments described herein, and may be modified or adapted without departing from the scope of the present invention.

### LIST OF REFERENCE NUMERALS

2 wind turbine
4 tower
6 nacelle
8 hub
10 blade
14 blade tip
16 blade root
18 leading edge
20 trailing edge
22 pitch axis
30 root region
32 transition region
34 airfoil region
40 shoulder/position of maximum chord
50 airfoil profile
52 pressure side
54 suction side
56 leading edge
58 trailing edge
60 chord
62 camber line/median line
70 support element
72 channel member
73 first lateral edge of channel member
74 second lateral edge channel member
75 inner surface
76 outer surface
77 slit
78 first portion of channel member
79 second portion of channel member
80 hollow passageway
81 arched wall
82 straight wall
83 web/rib
84 indentation/alignment feature
85 fibre material
86 adhesive tape
87 moulding surface of preform mould
88 strip member
89 top surface of strip member
90 preform mould
91 vacuum bag
92 vacuum source
93 tubes
94 fibre material
95 opening/hole
96 blade mould
97 blade mould cavity
98 preform
100 mould assembly
102 left lateral edge of preform moulding surface
104 right lateral edge of preform moulding surface
106 rear edge of preform moulding surface
108 front edge of preform moulding surface
c chord length
dₜ position of maximum thickness
d_{f} position of maximum camber
dₚ position of maximum pressure side camber
f camber
L blade length
Lc longitudinal axis of channel member
Wc width of channel member
Hc height of channel member
Le length of channel member
r local radius, radial distance from blade root
t thickness
Δy prebend

1. A method of manufacturing a part for a wind turbine blade, the method comprising the steps of
providing a mould (90) comprising a mould surface,
fastening one or more channel members (72) to the mould surface, each channel member (72) having a longitudinal axis, an inner surface (75) and an opposing outer surface (76),
laying a fibre material (85) and optionally a binding agent on the mould surface (87),
covering the fibre material, the optional binding agent and the one or more channel members with a vacuum bag, and
applying negative pressure to the fibre material and the optional binding agent via the one or more channel members for consolidating the part,
wherein each channel member (72) comprises a plurality of slits (77) extending between its inner surface and its outer surface, the slits having an orientation that is substantially transverse to the longitudinal axis of the channel member.

2. A method according to claim 1, wherein the part is a preform, and wherein the mould is a preform mould.

3. A method according to claim 1, wherein each channel member (72) has a longitudinally extending first lateral edge (73) and an opposing longitudinally extending second lateral edge (74), wherein each of the plurality of slits (77) passes through the second lateral edge (74).

4. A method according to claim 1, wherein each channel member (72) has a length and a width, wherein each of the plurality of slits (77) extends along 10-90% of the width of the channel member (72).

5. A method according to claim 1, wherein each channel member (72) comprises a first portion (78) extending along the longitudinal axis of the channel member (72) and defining a hollow passageway (80).

6. A method according to claim 5, wherein each channel member (72) comprises a substantially flat second portion (79) laterally adjacent to the first portion (78), the second portion extending along the longitudinal axis of the channel member (72).

7. A method according to claim 6, wherein the first portion comprises an arched wall (81) and wherein the second portion comprises a straight wall (82).

8. A method according to claim 5, wherein the first portion (78) of the channel member (72) comprises one or more longitudinally extending ribs or webs (83) extending from the inner surface (75) of the channel member (72).

9. A method according to claim 1, wherein each channel member (72) has a substantially P-shaped transverse cross section.

10. A method according to claim 1, wherein the outer surface of the channel member (72) comprises an alignment feature comprising an indentation (84), preferably a longitudinally extending indentation, in the outer surface of the channel member (72), the indentation extending along the length of the channel member (72).

11. A method according to claim 1, wherein the channel members are re-usable in that they are permanently fixed, e.g. using to an adhesive, to the mould surface of the mould.

12. A method according to claim 1, wherein the mould comprises one or more openings (95), such as one or more cylindrical openings, formed in the mould surface (87), each opening being in communication with a vacuum source (92), each opening being covered by a channel member (72) fastened to the mould surface.

13. A method of manufacturing a wind turbine blade part, the method comprising:
manufacturing one or more preforms according to the method of claim 1,
arranging the preforms in a blade mould cavity, optionally together with additional material,
infusing resin to the blade mould cavity,
curing or hardening the resin in order to form the blade part.

14. A mould assembly (100) for carrying out a method according to claim 1, the mould assembly comprising
a mould (90) comprising a mould surface, and
one or more channel members (72), each channel member (72) extending along a longitudinal axis and having an inner surface (75) and an opposing outer surface (76),
wherein each channel member (72) comprises a plurality of slits (77) extending between its inner surface and its outer surface, the slits having an orientation that is substantially transverse to the longitudinal axis of the channel member (72).

15. A mould assembly according to claim 14, wherein each channel member (72) has a first lateral edge (73) and an opposing second lateral edge (74), wherein each of the plurality of slits (77) passes through the second lateral edge.

16. A mould assembly according to claim 14, wherein each channel member (72) comprises a first portion (78) extending along the longitudinal axis of the channel member (72) and defining a hollow passageway, and a substantially flat second portion (79) laterally adjacent to the first portion, the second portion extending along the longitudinal axis of the channel member (72).
